(19) United States
(12) Patent Application Publication
(10) Pub. No.: US 2012/0003581 A1
(43) Pub. Date: Jan. 5, 2012

(54) METHOD OF MANUFACTURING WAX-CONTAINING POLYMER PARTICLES

(76) Inventors: Xiqiang Yang, Webster, NY (US); James R. Bennett, Rochester, NY (US)

(21) Appl. No.: 12/826,832

(22) Filed: Jun. 30, 2010

(51) Int. Cl. G03G 9/087

(52) U.S. Cl. 430/137.14

(57) ABSTRACT

The present invention is directed towards methods of manufacturing wax-containing polymer particles by limited coalescence processes employing aqueous wax dispersions. In one embodiment, an aqueous wax dispersion or emulsion is dispersed in an oil phase comprising a water-immiscible solvent and a polymer to form a transient water-in-oil (W/O) emulsion, and a further aqueous phase containing a particulate stabilizer is then added to the W/O emulsion to induce phase inversion, and the mixture homogenized to form an oil-in-water (O/W) emulsion. The solvent is then removed from the emulsion to form particles containing wax domains inside. In another embodiment, the aqueous wax dispersion is first mixed with the aqueous phase containing the particulate stabilizer, and homogenization is made with the oil phase to form an O/W emulsion, from which wax-containing particles are obtained after solvent removal. In still further embodiments, the aqueous wax dispersion is used in the second water phase of a double emulsion (W1/O/W2) process to form porous polymer particles containing the wax.

### FIELD OF THE INVENTION

The present invention relates to a method for the manufacture of wax-containing polymer particles, more particular of manufacturing chemically prepared toners and, more particularly, to a process of producing chemically prepared electrophotographic toners containing wax as releasing agent.

### BACKGROUND OF THE INVENTION

Conventional electrostatographic toner powders are made up of a binder polymer and other ingredients, such as pigment and a charge control agent, that are melt blended on a heated roll or in an extruder. The resulting solidified blend is then ground or pulverized to form a powder. Inherent in this conventional process are certain drawbacks. For example, the binder polymer must be brittle to facilitate grinding. Improved grinding can be achieved at lower molecular weight of the polymeric binder. However, low molecular weight binders have several disadvantages; they tend to form toner/developer flakes; they promote scumming of the carrier particles that are admixed with the toner powder for electrophotographic developer compositions; their low melt elasticity increases the off-set of toner to the hot fuser rollers of the electrophotographic copying apparatus, and the glass transition temperature (Tg) of the binder polymer is difficult to control. In addition, grinding of the polymer results in a wide particle size distribution, and air classification is often used to collect the fraction of toner of desired particle size. Consequently, the yield of useful toner is lower and manufacturing cost is higher. Also the toner fines accumulate in the developer station of the copying apparatus and adversely affect the developer life.

The preparation of toner polymer powders from a preformed polymer by the chemically prepared toner process such as the “evaporative limited coalescence” (ELC) offers many advantages over the conventional grinding method of producing toner particles. In this process, polymer particles having a narrow size distribution are obtained by forming a solution of a polymer in a solvent that is immiscible with water, dispersing the solution so formed in an aqueous medium containing a solid colloidal stabilizer and removing the solvent. The resultant particles are then isolated, washed and dried.

In the practice of this technique, polymer particles are prepared from any type of polymer that is soluble in a solvent that is immiscible with water. The size and size distribution of the resulting particles can be predetermined and controlled by the relative quantities of the particular polymer employed and the solvent used, the quantity and size of the water insoluble solid particulate suspension stabilizer, typically silica or latex, and the size to which the solvent-polymer droplets are reduced by mechanical shearing using rotor-stator type colloid mills, high pressure homogenizers, agitation etc.

Limited coalescence techniques of this type have been described in numerous patents pertaining to the preparation of electrostatic toner particles because such techniques typically result in the formation of polymer particles having a substantially uniform size distribution. Representative limited coalescence processes employed in toner preparation are described in U.S. Pat. Nos. 4,833,060; 4,965,131; 6,544,705; 6,682,866; and 6,800,412; and U.S. Publication No. 2004/0161687, incorporated herein by reference for all that they contain.

This technique generally includes the following steps: mixing a polymer material, a solvent and optionally a colorant and a charge control agent to form an organic phase; dispersing the organic phase in an aqueous phase comprising a particulate stabilizer and homogenizing the mixture; evaporating the solvent and washing and drying the resultant product.

Waxes may be incorporated into polymer particles such as electrophotographic toners to aid their release from the fuser roller surfaces, without the need to use fuser oil, such as silicone oil, at the fuser. The use of waxes in toners thus enables the so-called “oil-less fusing” of these toners. Additionally, wax in the toner may also improve anti-blocking property of the printed image.

Conventional methods for incorporating waxes into toner particles have been dependent on the type of manufacturing processes employed. U.S. Pat. No. 5,756,244, e.g., discloses a method of incorporating wax into the toner at the compounding step, where all the ingredients of the toner and the wax are added to the equipment such as an extruder, two-roll mill, kneader etc. Typically, the wax is dispersed in the molten state under the processing conditions without an added dispersant to ensure uniform, small wax domains. As a result, when the extruded matrix is pulverized the resulting particles may contain free wax particles or non-homogeneous distribution of wax in the particles, with a high content of surface wax. The surface wax and free wax can adversely affect the performance of the toner in the machine.

U.S. Pat. No. 7,026,087 discloses toner compositions made by melt-kneading toner materials including binder resin, wax, colorant, and a wax dispersant comprising a copolymer of an alpha-olefin, maleic anhydride and maleic anhydride monoester. As the components are melt-kneaded, there is no need for formation of a wax dispersion in an organic solvent in such a process.

It has been found that incorporating fine particles of wax into chemically prepared toners (CPT) results in toners that have little free wax and low surface wax compared to standard melt-pulverized toners. There are different ways of incorporating wax into toners made by chemical preparation. In U.S. Publication No. 2004/0161687, small wax particles obtained commercially are added to a solvent phase containing the rest of the toner materials. This organic phase is dispersed in an aqueous phase containing a water soluble surfactant and viscosity modifier to aid in the dispersion. However, the choice of waxes that are readily available with the desired small size is limited.

Aside from the relative amount of wax in the toner, the domain sizes of these waxes in the toner particles affect many properties of the toner, including the powder flow, tribocharging, release from the fuser surface and glossing. The particle size in a wax dispersion may be controlled for example, in a separate step by milling the wax to form a dispersion of the wax in a fluid medium. For chemical preparation of toners through the ELC process, it has been common practice that the wax is milled to desired size in an organic solvent and subsequently incorporated by addition into the oil phase. While the wax domain size can be reduced during milling without a dispersing aid, it is usually desirable to have a milling aid that can act as a colloidal stabilizer for the wax particles. The stabilizer is intended to prevent agglomeration of the wax particles thereby increasing the efficiency of milling and reducing the viscosity of the dispersion, allowing for higher yields and consequently lower milling costs. Commonly a stock of wax dispersion in organic solvent is prepared and used in toner formulation and manufacture.

Methods of manufacturing wax dispersions in organic solvents for CPT production have been disclosed. These generally include forming a solution of a solvent and a dispersant, in which the wax is milled to form a dispersion. A polymer of partially or fully hydrogenated styrene butadiene wherein the styrene mole fraction of the polymer is from 20 to 90, is used as dispersant in U.S. Publication No. 2007/0299191. A polymer comprising a wax-compatible polyolefin segment and a polyester compatible oleophilic polar segment is disclosed as wax dispersant in U.S. Publication No. 2009/0286911.

In an evaporative limited coalescence process for chemically prepared toner that also contains a wax as releasing agent, a wax dispersion is normally prepared in an organic solvent and then incorporated by addition into the oil phase. The oil phase essentially contains all the components that make up the final toner particle.

All of the above methods of incorporating the wax involve preparing the organic phase by using a wax dispersion in an organic solvent. In fact the wax dispersion is most often generated in the same organic solvent that is used to dissolve the polymer binder.

While organic phase based wax dispersions can generally be manufactured on a large scale, for toner preparation the solvents used normally need to be low boiling so that they may be easily removed and absent in the final toner product. Handling these dispersions containing low boiling solvent is often problematic; e.g., solvent loss by evaporation may lead to aggregation of wax particles and instability of the dispersion.

On the other hand, there have been numerous methods of producing wax dispersions in aqueous media. It is desirable to use an aqueous wax dispersion in the manufacture of chemically prepared toner.

For CPTs made by the emulsion aggregation technology, aqueous dispersions of wax, latex, pigment and charge control agent are mixed in a reactor and aggregated to form toner-sized particles. Aqueous dispersions of wax can be prepared by several methods. U.S. Pat. Nos. 6,849,371 and 6,210,853 disclose the preparation of wax dispersions by using a sulfonated polyester as a dispersant, which is also the toner binder, raising the aqueous dispersion temperature to above the melting point of the wax, using a high pressure reactor and then emulsifying the wax. U.S. Pat. No. 6,808,851 discloses a similar method with an anionic surfactant as the stabilizer. U.S. Publication No. 2004/0044108 describes the details of preparing the wax dispersions. However, it is substantially more difficult to carry out the emulsion aggregation process and incorporate the wax, than by using a solvent to dissolve and disperse the toner components, e.g., in an ELC process.

U.S. Publication No. 2007/0048655 describes a method of using an optional aqueous wax dispersion in a limited coalescence suspension polymerization process to prepare dry toner particles. The aqueous wax dispersion is first mixed with a pigment and resin mixture to form a paste which is subsequently compounded at high temperature and then dispersed in a monomer organic phase. This organic phase is used in a typical limited coalescence suspension polymerization process to form toner particles. U.S. Publication No. 2007/0048642 uses a similar paste and compounding method of incorporating aqueous wax dispersion in an evaporative limited coalescence process by using preformed polymer resin and a low boiling solvent. Thus, the wax is incorporated in the oil phase similar to that in a typical ELC process.

Therefore it would be advantageous to use aqueous wax dispersions directly in an ELC process for chemically prepared toner production without using complicated processes or equipment.

### SUMMARY OF THE INVENTION

It is an object of the present invention to eliminate the need for obtaining organic solvent based wax dispersions for the manufacture of chemically prepared toners by the evaporative limited coalescence process.

It is another object of the present invention to provide a method of incorporating aqueous wax dispersions into polymer particles and in particular a chemically prepared toner product.

It is still another object of the present invention to provide a method of incorporating aqueous wax dispersions into porous polymer particles such as a porous toner particles.

In accordance with the invention, a method of manufacturing wax-containing polymer particles using a limited coalescence process is described comprising: dissolving a polymer binder in a water immiscible organic solvent to form an organic phase solution; combining the organic phase solution with an aqueous phase containing a particulate stabilizer; and emulsifying the resulting mixture to form an oil in water emulsion; wherein either (i) an aqueous wax dispersion is added to the organic phase solution to form a transient water in oil emulsion in the organic phase solution prior to combining the organic phase solution with the aqueous phase containing particulate stabilizer, or (ii) the aqueous phase containing a particulate stabilizer combined with the organic phase solution further comprises an aqueous wax dispersion; and removing the solvent from the oil in water emulsion to form polymer particles with incorporated wax particles.

In one particular embodiment, an aqueous wax dispersion is added to the organic phase solution to form a transient water in oil emulsion in the organic phase solution prior to combining the organic phase solution with the aqueous solution containing particulate stabilizer, and a phase inversion of the transient water-in-oil emulsion is induced by addition of the aqueous phase containing a particulate stabilizer.

In an alternative embodiment, the aqueous phase containing a particulate stabilizer comprises an aqueous wax dispersion prior to being combined with the organic phase solution, and the organic phase is directly dispersed into the aqueous phase and then homogenized to form an oil-in-water emulsion.

In a further embodiment, the organic phase solution containing a polymer binder is in the form of a first water in oil emulsion formed by dispersing a first aqueous phase comprising a pore stabilizing hydrocolloid in the organic phase solution, and the first water in oil emulsion is dispersed in an aqueous phase containing particulate stabilizer and an aqueous wax dispersion to form a water in oil in water double emulsion; and shearing the double emulsion in the presence of the particulate stabilizer to form droplets of the first emulsion in the second aqueous phase; and removing the organic solvent from the droplets to form porous polymer particles with incorporated wax particles.

In accordance with the various embodiments of the invention, the wax dispersion employed may preferably comprise a dispersant having a hydrophilic-lipophilic balance (HLB) value of from about 9 to about 13.

### BRIEF DESCRIPTION OF THE DRAWINGS

FIG. 1 shows a photomicrograph of a water-in-oil emulsion after dispersing an aqueous wax dispersion into an oil phase containing a polymer binder in ethyl acetate solvent, as described in Example I-1.

### DETAILED DESCRIPTION OF THE INVENTION

Polymeric particles containing wax suitable for use as toner in the present invention in on embodiment may be prepared by the following steps: 1) forming an water-in-oil (W/O) emulsion using an aqueous wax dispersion and a polymer solution in a water-immiscible solvent, 2) inducing a phase inversion of the W/O emulsion by addition of an aqueous phase containing a particulate stabilizer, 3) homogenizing the mixture and obtaining an oil-in-water (O/W) emulsion, and 4) removing the solvent and collecting the toner product.

Alternatively, in accordance with a further embodiment of the invention, the aqueous wax dispersion may be incorporated in the aqueous phase containing the particulate stabilizer and mixed with the oil phase and homogenized to form the O/W emulsion. The solvent is then removed and toner particles collected.

In accordance with another embodiment of the invention, the aqueous wax dispersion may be incorporated in the aqueous phase containing the particulate stabilizer. Into this water phase is dispersed a water-in-oil emulsion comprising a first water phase that is stabilized with a hydrocolloid and an oil phase made of a polymer binder dissolved in a water immiscible organic solvent. The resulting double emulsion is homogenized with an extensional shearing device and the solvent subsequently removed to yield porous polymer particles containing wax.

Wax dispersions are sometimes also referred to as wax emulsions, and the dispersants for wax as emulsifiers. In the present invention, the two pairs of terms are used interchangeably within their intended description of the wax dispersion and surface active compounds, respectively.

Suitable aqueous wax dispersions useful in the instant invention may be made using a dispersant comprising a polymer, copolymer, block copolymer, or graft copolymer comprising a wax-compatible segment and a water compatible segment. Suitable dispersants for the aqueous wax dispersion within the scope of the present invention are those surfactants which can form oil-in-water emulsions while not strongly disrupting the limited coalescence by the particulate stabilizer, e.g., silica. This requires that the dispersants be weakly hydrophilic emulsifiers having an HLB (Hydrophilic-Lipophilic Balance) number of from about 9 to about 13, preferably greater than about 9 but less than about 13, and most preferably from about 10 to about 12 (on the HLB scale of 0-20). The HLB number is characteristic of a surfactant and is defined as in the literature such as “The HLB System, a time-saving guide to emulsifier selection”, ICI United States Inc., (1976), pp. 1-20. Preferred polymeric dispersants for the wax dispersion useful in the present invention comprise block and graft copolymers containing both wax compatible polyolefin segment(s) and hydrophilic segment(s). The block copolymers may be diblock or higher blocks.

Suitable dispersants include hydrophilic polyoxyethylene ether derivatives of various phenols and alkyl alcohols, and ester derivatives with common fatty acids. Among the suitable emulsifiers are hydrophilic polyoxyethylene derivatives of sorbitan monolaurate, sorbitan monopalmitate, sorbitan mono and tristearate, sorbitan mono- and trioleate, nonylphenol, 2,4,6-trimethyl-4-nonanol, tridecyl alcohol, lauryl alcohol, stearyl alcohol, and oleyl alcohol. The emulsifier may also be a mixture of hydrophilic and lipophilic emulsifiers (such as partial esters of common fatty acids) so long as there are sufficient hydrophilic emulsifiers present to render the overall mixture hydrophilic enough for dispersion in water.

By hydrophilic polar segment is meant a polar group or polymer segment that is at least partially soluble in water, and that, when mixed with water, the two are at least partially soluble or miscible with each other. Examples of the polar segments include but not limited to polyethyleneglycol, polypropyleneglycol, and the like.

The term wax compatible polyolefin segment is used herein to mean a polyolefin segment that, when mixed with a wax, is at least partially soluble or miscible with the wax, as evidenced by changes in the wax and/or polymer segment glass transition temperatures or crystallization behaviors of the mixture when compared with those of its constituents. Wax compatible polyolefin segments preferably have a molecular weight of at least 100. Examples of polyolefin segments include but are not limited to polyethylene, polypropylene, polybutadiene and hydrogenated polybutadiene, and poly(ethylene-co-butylene) segments.

Any wax with appropriate melting temperature range may be used for the purpose of the present invention. Examples of such waxes include polyolefins such as polyethylene wax and polypropylene wax, and long chain hydrocarbon waxes such as paraffin wax. Another class of wax is carbonyl group-containing waxes which include long-chain aliphatic ester waxes, as well as polyalkanoic acid ester waxes such as montan wax, trimethylolpropane tribehenate, glycerin tribehenate; polyalkanol ester waxes such as tristearyl trimellilate and distearyl maleate; polyalkanoic acid amide waxes such as trimellitic acid tristearyl amide. Examples of useful aliphatic amides and aliphatic acids include oleamide, eucamide, stearamide, behenamide, ethylene bis(oleamide), ethylene bis(stearamide), ethylene bis(behenamide) and long chain acids including stearic, lauric, montanic, behenic, oleic and tall oil acids. Particularly preferred aliphatic amides and acids include stearamide, erucamide, ethylene bis(stearamide) and stearic acid. The aliphatic amide or aliphatic acid is present in an amount from about 0.5 to 30 percent by weight, preferably from about 0.5 to 10 percent by weight. Mixtures of aliphatic amides and aliphatic acids can also be used. One useful stearamide is commercially available from Witco Corporation as Kemamide S™. A useful stearic acid is available from Witco Corporation as Hysterene 9718™. Naturally occurring polyalkanoic acid ester waxes include Carnauba wax. A particularly useful class of ester waxes is made from long chain fatty acids and alcohol. Examples of this class are Licowax series made by Clariant Corp. derived from montanic acid. Another example useful in toner applications is the WE series made by NOF which is a highly purified narrow melting solid ester wax. Fluorinated waxes such as Polyfluo 190, Polyfluo 200, Polyfluo 523×F, Aqua Polyfluo 411—all polyethylene/PTFE functionalized waxes, Aqua Polysilk 19, Polysilk 14—all polyethylene/PTFE/amide functionalized waxes available from Micro Powders INC are also useful. The choice of wax is not limited to a single wax. Two or more of the above waxes may be incorporated into the dispersion to give improved toner performance. The wax WE-3 made by NOF, a long-chain ester wax made from long chain fatty acids and alcohol, is a preferred wax because it has a narrow melting range with little melting that takes place below 40° C. Preferably, the wax employed has a percent crystallinity of greater than 50%.

Although the wax used in the present invention can have a broad range of applications, it is generally desired for toner applications that the wax have a melting point of 40-160° C., preferably 50-120° C., more preferably 60-90° C. A melting point of wax below 40° C. may adversely affect the heat resistance and preservability of the toner, while too high a melting point—i.e. in excess of 160° C.—is apt to cause cold offset of toner when the fixation is performed at a low temperature. Additionally, the melting peak of wax as obtained by methods such as differential scanning calorimetry, and it is preferred that the onset of melting to the peak melting temperature be greater than 20° C., preferably greater than 50° C. Preferably, the wax has a melt viscosity of 5-1000 cps, more preferably 10-100 cps, at a temperature higher by 20° C. than the melting point thereof. When the viscosity is greater than 1000 cps, the anti-hot offset properties and low fixation properties of the toner are adversely affected. The amount of the wax in the toner is generally 0.1 to 40 weight percent, preferably 0.5 to 10 weight percent, based on that of the toner.

Wax dispersions useful in the instant invention may also include other co-dispersants, such as nonionic polymers, for example, cellulose derivatives such as methyl cellulose, ethyl cellulose, and hydroxyethyl cellulose, and polyvinyl alcohol.

It is well known in the art that in order for the wax to perform well as a release agent, the wax blooms to the surface of the toner upon fusing. However, prior to the fusing step it is also desired that the wax be encapsulated by the toner binder. In order for this to happen, the wax particle size should be substantially smaller than the final desired size of the toner particle.

Thus, the wax dispersions useful for the present invention can be prepared by any one of several comminution processes. These include high-pressure/high-temperature homogenizers and high shear dispersers like the IKA mill, Kady mill or a Gaulin mill. Equipment used to homogenize emulsions may also be used, particularly where the wax particles are brittle at ambient operating temperatures. Media milling techniques are particularly useful for comminution of solid particles. Media milling can be accomplished by an attritor, a ball mill, a media mill or a vibration mill using media made of silica, silicon nitride, sand, zirconium oxide, alumina, titanium, glass, etc. The bead sizes typically range from 0.25 to 3.0 mm in diameter. The volume of the media can be from 5 to 200% of the volume of the dispersion containing the wax particles. The slurry containing the water with dissolved/dispersed polymer and wax particles added to the mill where repeated collisions of the milling media with the solid wax particles result in fracture and consequent particle size reduction. The milling process is continued till the desired particle size of the wax is obtained.

The slurry that is being milled contains the types of waxes described above and at least one dispersant. The weight percent amount of wax particles in the slurry can be from 0.1 to 50 weight percent. If the wax dispersion is further used to make electrophotographic toner, the time involved in processing a given amount of wax is directly proportional to the cost of making the toner. In order to maximize productivity and minimize the cost, it is desired that the wax content in the slurry be as high as possible. However, if it is too high, the viscosity of the slurry becomes high which can decrease the efficiency of milling (increase time for milling) and reduce the yield because it is hard to separate from the milling media. The rheological profile of the solid particle dispersion is typically shear thinning—i.e. its viscosity decreases as the rate of shear imparted increases. A partially stabilized or unstable dispersion will typically exhibit an extreme case of shear thinning where the viscosity at low shear rates (<0.5 s⁻¹) is high. In an extreme case an unstable, flocculated dispersion may exhibit a yield stress and may not flow at the low shear rates. The proper choice of dispersant will stabilize the particles and reduce the viscosity at low shear rates.

In order to make the wax milling process economically viable it is desired that the wax particles in the dispersion be well dispersed and with a median particle size less than 1 micron, more preferably from 0.2 to 0.8 microns. In order to achieve a stable and well dispersed wax dispersion, the dispersant should be present at a level from between 2 to 50 weight percent based on the amount of wax present. The preferred amount is from 5 to 25 weight percent. If the level is too low, there will not be enough dispersant to stabilize the wax particles when the size is reduced. If the level is too high, the polymer will comprise a significant portion of the toner when the dispersion is used to prepare the toner.

In order for the wax to be incorporated and to be uniformly dispersed in the final toner particles, compounds that can aid the even distribution of the wax particles can be used in the toner preparation process. Preferably these compounds are polymeric materials that are soluble or dispersible in the oil phase, and herein after referred to as dispersing aids. Further, the polymers are those that are dispersants and co-dispersants for solvent based wax dispersions. Suitable for this purpose are partially hydrogenated styrene-butadiene copolymers such as Tuftec P2000 from AK Elastomer, alpha-olefin/maleic anhydride (30+ carbons in alpha-olefin) such as Ceramer 1608 from Baker Petrolite, vinyl acetal polymers and copolymers, such as polyvinyl acetal, polyvinyl butyral, polyvinyl pental, and polyvinylhexal, and co-polymers thereof such as poly(vinyl butyral-co-vinyl hexyl), poly(vinyl butyral-co-vinyl heptal), poly(vinyl butyral-co-vinyl octal), and poly(vinyl butyral-co-vinyl naphthal), and other solvent soluble block copolymers as disclosed in U.S. Publication No. 2009/0286911. Such polymer dispersants preferably have an HLB value of about 2 to 10, and are used in the oil phase at an amount of about 2 to 30 weight percent relative to wax, or preferably at an amount of about 5 to 25 weight percent with respect to wax.

In the practice of the present invention, polymer particles are prepared from a polymer that is soluble in a solvent that is immiscible with water. In a preferred embodiment the toner is prepared by dissolving/dispersing the binder, optionally one or more pigments, one or more charge control agents in one or more of the preferred solvents. The wax dispersion of the instant invention is added to this mixture and mixed to form a W/O emulsion. The relative amount of W to O may be about 0.05:1 to 0.8:1 by weight. This emulsion may be transiently stable or unstable.

An aqueous phase containing a stabilizer is prepared and added to the W/0 emulsion to cause phase inversion. The preferred stabilizer is particulate and optionally, a promoter is used to drive the particulate stabilizer to the interface between the water layer and the polymer solvent droplets formed by homogenizing the system. Suitable colloidal stabilizers known in the art of forming polymeric particles by the limited coalescence technique can be employed such as, for example, inorganic materials such as, metal salt or hydroxides or oxides or clays, organic materials such as starches, sulfonated crosslinked organic homopolymers and resinous polymers as described, for example, in U.S. Pat. No. 2,932,629; silica as described in U.S. Pat. No. 4,833,060; and copolymers such as copoly(styrene-2-hydroxyethyl methacrylate-methacrylic acid-ethylene glycol dimethacrylate) as described in U.S. Pat. No. 4,965,131, all of which are incorporated herein by reference. Silica is the preferred suspension stabilizing agent for use in accordance with this invention. The silica stabilizer generally should have dimensions such that they are from about 0.001 μm to about 1 μm preferably from about 5 to 150 nanometers and most preferably from about 5 to 75 nanometers. The size and concentration of these particles control and predetermine the size of the final toner particle. Examples of colloidal silica are those sold under the brand names of Ludox, Nalcoag and Snowtex among others. Colloidal silicas are naturally charged negatively at pH greater than 2 and these are the preferred stabilizers. However, silica particles modified with alumina are positively charged and are also suitable as a stabilizer.

Suitable promoters to drive the suspension stabilizing agent to the interface of the lubricant droplets and the aqueous phase include sulfonated polystyrenes, alginates, carboxymethyl cellulose, tetramethyl ammonium hydroxide or chloride, triethylphenyl ammonium hydroxide, triethylphenyl ammonium hydroxide, triethylphenyl ammonium chloride, diethylaminoethylmethacrylate, gelatin, glue, casein, albumin, gluten, methoxycellulose, and the like. A particularly suited promoter is a water-soluble condensation product of diethanol amine and adipic acid, such as poly(adipic acid-co-methylaminoethanol), water soluble condensation products of ethylene oxide, urea, and formaldehyde and polyethyleneimine. In the case of colloidal silica as stabilizer, it is generally desired to control the pH of the system at a value of from about 2 to about 7, preferably from about 3 to 6 and most preferably 4. The promoter should be present in an amount of 1 to about 50 percent based on the amount of silica.

Addition of the water phase containing the particulate stabilizer and optionally the promoter to the water-in-oil emulsion causes a phase inversion due to the excess amount of water phase in the system. The dispersion so formed of the suspension droplets in the aqueous medium is then vigorously mixed by any suitable device including high speed agitation, ultrasonic devices, homogenizers, and the like in order to reduce the particle size of the lubricant droplets to less than that ultimately desired. The presence of the particulate suspension stabilizer then controls the level of coalescence that takes place until an equilibrium is reached and the particle size does not grow any farther. The size and size distribution of the resulting particles are predetermined and controlled by the relative quantities of the particular polymer and other toner components employed, the solvent, the quantity and the size of the water insoluble solid particulate stabilizer, typically silica or latex, and the size to which the solvent-polymer droplets are reduced by mechanical shearing.

The solvent is next removed from the droplets by any suitable technique, such as under reduced pressure. The solvent can also be removed by purging the stirred dispersion with air or an inert gas like nitrogen. U.S. Pat. No. 5,580,692 discloses a method by which excess water is added to the dispersion that extracts the solvent. The resulting toner particles are separated from the water/solvent mixture by filtration or centrifuge.

The silica stabilizer may be removed from the surface of the polymer particles if required by any suitable technique such as dissolving in HF or other fluoride ion or by adding an alkaline agent such as potassium hydroxide to the aqueous phase containing the polymer particles to thereby raise the pH to at least about 10 while stirring. The alkaline addition method is preferred. Subsequent to raising the pH and dispersing the silica, the polymer particles can be recovered by filtration or centrifugation and finally washed with water or other agents to remove any undesired impurities from the surface thereof. The toner particles thus produced can be dried and surface treated to produce usable toner for electrophotographic engines.

As stated above, the toner may optionally have charge control agents incorporated in them. The term charge-control agent refers to a toner addendum used to modify the triboelectric charging properties of the resulting toner. A very wide variety of charge control agents for positive and negative charging toners are available. Suitable charge control agents are disclosed, for example, in U.S. Pat. Nos. 3,893,935; 4,079,014; 4,323,634; and 4,394,430; and British Patent Numbers 1,501,065 and 1,420,839, all of which are incorporated in their entireties by reference herein. Additional charge control agents which are useful are described in U.S. Pat. Nos. 4,624,907; 4,814,250; 4,840,864; 4,834,920; 4,683,188; and 4,780,553 all of which are incorporated in their entireties by reference herein. Mixtures of charge control agents can also be used. Particular examples of charge control agents include chromium salicylate organo-complex salts, and azo-iron complex-salts, an azo-iron complex-salt, particularly ferrate (1-), bis[4-[(5-chloro-2-hydroxyphenyl)azo]-3-hydroxy-N-phenyl-2-naphthalenecarb oxamidato(2-)], ammonium, sodium, and hydrogen (Organoiron available from Hodogaya Chemical Company Ltd.).

The binders useful in the practice of the present invention can be any type of polymer or resin. Preferred are polymers that are suitable as the binder for dry electrophotographic toners such as vinyl polymers, acrylic polymers, polyesters, polyurethane resins, epoxy resins, silicone resins, polyamide resins, modified rosins, and the like. Particularly polymers include polyesters of aromatic or aliphatic dicarboxylic acids with one or more aliphatic diols, such as polyesters of isophthalic or terephthalic or fumaric acid with diols such as ethylene glycol, cyclohexane dimethanol and bisphenol adducts of ethylene or propylene oxides. Especially preferred is a polymer suitable for ELC which means it is capable of being dissolved in a solvent that is immiscible with water wherein the polymer itself is substantially insoluble in water such as Kao E and Kao N from Kao Corporation, and Piccotoner 1221 from BASF.

Preferably the acid values (expressed as milligrams of potassium hydroxide per gram of resin) of the polyester resins are in the range of 2 to 100. The polyesters may be saturated or unsaturated. Of these resins, styrene/acryl and polyester resins are particularly preferable. In the practice of this invention, it is particularly advantageous to utilize resins having a viscosity in the range of 1 to 100 centipoise when measured as a 20 weight percent solution in ethyl acetate at 25″ C.

Pigments suitable for use in the practice of the present invention are disclosed, for example, in U.S. Reissue Pat. No. 31,072 and in U.S. Pat. Nos. 4,414,152 and 4,416,965. As the colorants, known colorants can be used. The colorants include, for example, carbon black, Aniline Blue, Calcoil Blue, Chrome Yellow, Ultramarine Blue, DuPont Oil Red, Quinoline Yellow, Methylene Blue Chloride, Phthalocyanine Blue, Malachite Green Oxalate, Lamp Black, Rose Bengal, C.I. Pigment Red 48:1, C.I. Pigment Red 122, C.I. Pigment Red 57:1, C.I. Pigment Yellow 97, C.I. Pigment Yellow 12, C.I. Pigment Yellow 17, C.I. Pigment Blue 15:1 and C.I. Pigment Blue 15:3. Colorants can generally be employed in the range of from about 1 to about 90 weight percent on a total toner powder weight basis, and preferably in the range of about 2 to about 20 weight percent, and most preferably from 4 to 15 weight percent in the practice of this invention. When the colorant content is 4 weight percent, a sufficient coloring power can be obtained, and when it is 15 weight percent or less, good transparency can be obtained. Mixtures of colorants can also be used. Colorants in any form such as dry powder, its aqueous or oil dispersions, or wet cake can be used in the present invention. Colorant milled by any methods like media-mill or ball-mill can be used as well.

Any suitable organic solvent that will dissolve the polymer and which is also immiscible with water may be used, such as for example, chloromethane, dichloromethane, ethyl acetate, propyl acetate, vinyl chloride, trichloromethane, carbon tetrachloride, ethylene chloride, trichloroethane, toluene, xylene, cyclohexanone, 2-nitropropane, and the like. Particularly useful solvents are ethyl acetate and propyl acetate for the reason that they are both good solvents for many polymers while at the same time are immiscible with water. Further, their volatility is such that they are readily removed from the discontinuous phase droplets as described below, by evaporation.

Optionally, the solvent that will dissolve the binder polymer and which is immiscible with water may be a mixture of two or more water-immiscible solvents chosen from the list given above.

The average particle diameter of the discrete wax-containing polymer particles of the present invention is, for example, 2 to 50 micrometers, preferably 3 to 20 micrometers.

The discrete particles of this invention can be spherical or irregular in shape. However, the shape of toner particles has a bearing on the electrostatic toner transfer and cleaning properties. Thus, for example, the transfer and cleaning efficiency of toner particles have been found to improve as the sphericity of the particles is reduced. A number of procedures to control the shape of toner particles are known in the art. In the practice of this invention, additives may be employed in the water phase or in the oil phase if necessary. The additives may be added after or prior to forming the oil-in-water emulsion. In either case the interfacial tension is modified as the solvent is removed resulting in a reduction in sphericity of the particles. U.S. Pat. No. 5,283,151 describes the use of carnauba wax to achieve a reduction in sphericity of the particles. U.S. Pat. No. 7,662,535 describes the use of certain metal carbamates that are useful to control sphericity and U.S. Pat. No. 7,655,375 describes the use of specific salts to control sphericity. US Publication No. 2007/0298346 entitled “TONER PARTICLES OF CONTROLLED MORPHOLOGY” describes the use of quaternary ammonium tetraphenylborate salts to control sphericity. The disclosures of these applications are incorporated by reference herein in their entireties.

Toner particles of the present invention may also contain flow aids in the form of surface treatments. Surface treatments are typically in the form of inorganic oxides or polymeric powders with typical particle sizes of 5 nm to 1000 nm. With respect to the surface treatment agent also known as a spacing agent, the amount of the agent on the toner particles is an amount sufficient to permit the toner particles to be stripped from the carrier particles in a two component system by the electrostatic forces associated with the charged image or by mechanical forces. Preferred amounts of the spacing agent are from about 0.05 to about 10 weight percent, and most preferably from about 0.1 to about 5 weight percent, based on the weight of the toner.

The spacing agent can be applied onto the surfaces of the toner particles by conventional surface treatment techniques such as, but not limited to, conventional powder mixing techniques, such as tumbling the toner particles in the presence of the spacing agent. Preferably, the spacing agent is distributed on the surface of the toner particles. The spacing agent is attached onto the surface of the toner particles and can be attached by electrostatic forces or physical means or both. With mixing, uniform mixing is preferred and achieved by such mixers as a high energy Henschel-type mixer which is sufficient to keep the spacing agent from agglomerating or at least minimizes agglomeration. Furthermore, when the spacing agent is mixed with the toner particles in order to achieve distribution on the surface of the toner particles, the mixture can be sieved to remove any agglomerated spacing agent or agglomerated toner particles. Other means to separate agglomerated particles can also be used for purposes of the present invention.

The preferred spacing agent is silica, such as those commercially available from Degussa, like R-972, or from Wacker, like H2000. Other suitable spacing agents include, but are not limited to, other inorganic oxide particles, polymer particles and the like. Specific examples include, but are not limited to, titania, alumina, zirconia, and other metal oxides; and also polymer particles preferably less than 1 μm in diameter (more preferably about 0.1 μm), such as acrylic polymers, silicone-based polymers, styrenic polymers, fluoropolymers, copolymers thereof, and mixtures thereof.

In another embodiment of the present invention, aqueous wax dispersions may also be incorporated in porous particles, especially those useful as electrophotographic toners as described in US Publication Numbers 2008/0176157, 2008/0176164, 2009/0098288, and 2010/0021838, the disclosures of which are incorporated herein in their entireties. Such porous particles may include “micro,” “meso,” and “macro” pores, which according to the International Union of Pure and Applied Chemistry are the classifications recommended for pores less than 2 nm, 2 to 50 nm, and greater than 50 nm respectively. The term porous particles will be used herein to include pores of all sizes, including open or closed pores. Porous particles employed in preferred embodiments of the invention preferably have a porosity of at least 10 percent.

One suitable process for making porous polymer particles as described in the above referenced patent applications involves basically a three-step process. The first step involves the formation of a stable water-in-oil emulsion, including a first aqueous solution of a pore stabilizing hydrocolloid dispersed finely in a continuous phase of a binder polymer dissolved in an organic solvent. This first water phase creates the pores in the particles of this invention and the pore stabilizing compound controls the pore size and number of pores in the particle, while stabilizing the pores such that the final particle is not brittle or fractured easily.

Suitable pore stabilizing hydrocolloids include both naturally occurring and synthetic, water-soluble or water-swellable polymers such as, cellulose derivatives e.g., carboxymethyl cellulose (CMG) also referred to as sodium carboxy methyl cellulose, gelatin e.g., alkali-treated gelatin such as cattle bone or hide gelatin, or acid treated gelatin such as pigskin gelatin, gelatin derivatives e.g., acetylated gelatin, phthalated gelatin, and the like, substances such as proteins and protein derivatives, synthetic polymeric binders such as poly(vinyl alcohol), poly(vinyl lactams), acrylamide polymers, polyvinyl acetals, polymers of alkyl and sulfoalkyl acrylates and methacrylates, hydrolyzed polyvinyl acetates, polyamides, polyvinyl pyridine, methacrylamide copolymers, water soluble microgels, polyelectrolytes and mixtures thereof.

In order to stabilize the initial first step water-in-oil emulsion so that it can be held without ripening or coalescence, if desired, it is preferable that the hydrocolloid in the water phase have a higher osmotic pressure than that of the binder in the oil phase depending on the solubility of water in the oil. This dramatically reduces the diffusion of water into the oil phase and thus the ripening caused by migration of water between the water droplets. One can achieve a high osmotic pressure in the water phase either by increasing the concentration of the hydrocolloid or by increasing the charge on the hydrocolloid (the counter-ions of the dissociated charges on the hydrocolloid increase the osmotic pressure of the hydrocolloid). It can be advantageous to have weak base or weak acid moieties in the pore stabilizing hydrocolloid that allow for the osmotic pressure of the hydrocolloid to be controlled by changing the pH. We call these hydrocolloids “weakly dissociating hydrocolloids.” For these weakly dissociating hydrocolloids the osmotic pressure can be increased by buffering the pH to favor dissociation, or by simply adding a base (or acid) to change the pH of the water phase to favor dissociation. A preferred example of such a weakly dissociating hydrocolloid is CMC that has a pH sensitive dissociation (the carboxylate is a weak acid moiety). For CMC the osmotic pressure can be increased by buffering the pH, for example using a pH 6-8 phosphate buffer, or by simply adding a base to raise the pH of the water phase to favor dissociation (for CMC the osmotic pressure increases rapidly as the pH is increased from 4 to 8).

Other synthetic polyelectrolytes hydrocolloids such as polystyrene sulphonate (PSS) or poly(2-acrylamido-2-methylpropanesulfonate) (PAMS) or polyphosphates are also possible hydrocolloids. These hydrocolloids have strongly dissociating moieties. While the pH control of osmotic pressure that can be advantageous, as described above, is not possible due to the strong dissociation of charges for these strongly dissociating polyelectrolyte hydrocolloids, these systems will be insensitive to varying level of acid impurities. This is a potential advantage for these strongly dissociating polyelectrolyte hydrocolloids particularly when used with binder polymers that have varying levels of acid impurities such as polyesters.

The essential properties of the pore stabilizing hydrocolloids are solubility in water, no negative impact on multiple emulsification process, and no negative impact on melt rheology of the resulting particles that is important in fusing of the particles after printing. The pore stabilizing compounds can be optionally cross-linked in the pore to minimize migration of the compound to the surface. The amount of the hydrocolloid used in the first step will depend on the amount of porosity and size of pores desired and the molecular weight of the hydrocolloid. A particularly preferred hydrocolloid is CMC and in an amount of from 0.5 to 20 weight percent of the binder polymer, preferably in an amount of from 1 to 10 weight percent of the binder polymer.

The first aqueous phase may additionally contain, if desired, salts to buffer the solution and to optionally control the osmotic pressure of the first aqueous phase as described earlier. For CMC the osmotic pressure can be increased by buffering using a pH 7 phosphate buffer. It may also contain additional porogen or pore forming agents such as ammonium bicarbonate.

The oil phase contains the binder polymer solution in the water immiscible solvent along with various additives generally present in electrostatograhic toner such as colorants, and charge control agents. The order of addition is not important.

The second step in the formation of the porous particles involves forming a water-in-oil-in-water emulsion by dispersing the above mentioned water-in-oil emulsion in a second aqueous phase containing wax dispersion and either stabilizer polymers such as poylvinylpyrrolidone or polyvinylalchol or more preferably colloidal silica such as Ludox or latex particles in a modified ELC process described in U.S. Pat. Nos. 4,883,060; 4,965,131; 2,934,530; 3,615,972; 2,932,629; and 4,314.932; the disclosures of which are hereby incorporated by reference.

Specifically, in the second step of the process of the formation of porous particles, the water-in-oil emulsion is mixed with the second aqueous phase containing colloidal silica stabilizer and the wax dispersion to form an aqueous suspension of droplets that is subjected to shear or extensional mixing or similar flow processes, preferably through an orifice device to reduce the droplet size, yet above the particle size of the first water-in-oil emulsion, and achieve narrow size distribution droplets through the limited coalescence process. The pH of the second aqueous phase is generally between 4 and 7 when using silica as the colloidal stabilizer.

The suspension droplets of the first water-in-oil emulsion in the second aqueous phase, results in droplets of resin dissolved in oil containing the first aqueous phase as finer droplets within the bigger resin droplets, which upon drying produces porous domains in the resultant particles of resin. The actual amount of silica used for stabilizing the droplets depends on the size of the final porous particle desired as with a typical limited coalescence process, which in turn depends on the volume and weight ratios of the various phases used for making the multiple emulsion.

Any type of mixing and shearing equipment may be used to perform the first step of this invention, such as a batch mixer, planetary mixer, single or multiple screw extruder, dynamic or static mixer, colloid mill, high pressure homogenizer, sonicator, or a combination thereof. While any high shear type agitation device is applicable to this step of the present invention, a preferred homogenizing device is the MICROFLUIDIZER such as Model No. 110T produced by Microfluidics Manufacturing. In this device, the droplets of the first water phase (discontinuous phase) are dispersed and reduced in size in the oil phase (continuous phase) in a high shear agitation zone and, upon exiting this zone, the particle size of the dispersed oil is reduced to uniform sized dispersed droplets in the continuous phase. The temperature of the process can be modified to achieve the optimum viscosity for emulsification of the droplets and to control evaporation of the solvent. For the second step, where the water-in-oil-in-water emulsion is formed the shear or extensional mixing or flow process is controlled in order to prevent disruption of the first emulsion and droplet size reduction is achieved by homogenizing the emulsion through a capillary orifice device, or other suitable flow geometry. In the method of this invention, the range of back pressure suitable for producing acceptable particle size and size distribution is between 100 and 500 psi, preferably between 500 and 2000 psi. The preferable flow rate is between 1000 and 6000 mL per minute.

The final size of the particle, the final size of the pores and the surface morphology of the particle will be impacted by the osmotic mismatch between the osmotic pressure of the inner water phase, the organic binder phase and the outer water phase. At each interface, the larger the osmotic pressure gradient present, the faster the diffusion rate where water will diffuse from the lower osmotic pressure phase to the higher osmotic pressure phase. If either the exterior water phase or the interior water phase has an osmotic pressure less than the organic binder phase then water will diffuse into and saturate the organic binder phase. For the preferred organic phase solvent of ethyl acetate this can result in approximately 8 weight percent water dissolved in the organic phase. If the osmotic pressure of the exterior water phase is higher than the binder phase then the water will migrate out of the pores of the particle and reduce the porosity and particle size. In order to maximize porosity one preferably orders the osmotic pressures so that the osmotic pressure of the outer phase is lowest, while the osmotic pressure of the interior water phase is highest. Thus, the water will diffuse following the osmotic gradient from the external water phase into the organic binder phase and then into the internal water phase swelling the size of the pores and increasing the porosity and particle size.

If it is desirable to have small pores and maintain the initial small drop size formed in the step one emulsion then the osmotic pressure of both the interior and exterior water phase should be preferably matched, or have a small osmotic pressure gradient. It is also preferable that the osmotic pressure of the exterior and interior water phases be higher than the organic binder phase. When using weakly dissociating hydrocolloids such as CMC, one can change the pH of the exterior water phase using acid or a buffer preferably a pH 4 citrate buffer. The hydrogen and hydroxide ions diffuse rapidly into the interior water phase and equilibrate the pH with the exterior phase. The drop in pH of the interior water phase containing the CMC thus reduces the osmotic pressure of the CMC. By designing the equilibrated pH correctly one can control the osmotic pressure of the first water phase and thus the final porosity and particle size.

One can also control the surface morphology as to whether there are open pores (surface craters) or closed pores (a surface shell). If the osmotic pressure of the interior water phase is sufficiently low relative to the exterior water phase the pores near the surface will burst to the surface and create an “open pore” surface morphology during drying in the third step of the process.

The third step in the preparation of the porous particles of this invention involves removal of the solvent that is used to dissolve the binder polymer and to produce a suspension of uniform porous polymer particles in aqueous solution. The rate, temperature and pressure during drying will also impact the final particle size and surface morphology. Clearly the details of the importance of this process depend on the water solubility and boiling point of the organic phase relative to the temperature of drying process. Solvent removal apparatus such as a rotary evaporator or a flash evaporator may be used in the practice of the method of this invention. The polymer particles are isolated followed by drying in an oven at 40° C. that also removes any water remaining in the pores from the first water phase. Optionally, the particles are treated with alkali to remove the silica stabilizer.

Optionally, the third step in the preparation of porous particles described above may be preceded by the addition of additional water prior to removal of the solvent and drying.

The average particle diameter of porous toner obtained by the described process typically may be, for example, 3 to 50 micrometers, preferably 3 to 20 micrometers.

The invention will further be illustrated by the following examples. They are not intended to be exhaustive of all possible variations of the invention.

### EXAMPLES

### Materials

The wax used in the examples was the ester wax WE-3® from NOF Corporation. The wax dispersants used in the examples are given in Table 1.

The binder used for making toners containing the wax by the methods of this invention was Kao E, a Bisphenol-A based polyester polymer obtained from Kao Specialties Americas LLC, a part of Kao Corporation, Japan. The cyan pigment used in the present invention is Pigment Blue 15:3 from Sun Chemical, either as a master batch at 40 weight percent in a polyester binder made of fumaric acid and Bisphenol A, or as a dispersion in ethyl acetate prepared by milling in the presence of Solsperse 32000 (25 weight percent with respect to pigment) and Solsperse 12000 (6 weight percent with respect to pigment), both from Lubrizol Advanced Materials, Inc. Solsperse 32000 is a polyester-polyamide resin and Solsperse 12000 is a pigmentary synergist agent. Tuftec P2000, a partially (selectively) hydrogenated polystyrene-butadiene thermoplastic elastomer polymer, was from Asahi Kasei Chemical Corporation. Charge control agent FCA 2508N was from Fujikura Kasei Co., Ltd. Carboxymethyl cellulose (CMC), as sodium salt, molecular weight approximately 250,000 and degree of substitution of 0.7 was AQUALON® CMC-9M31F from Hercules. Nalco 1060, a colloidal silica, was obtained from Nalco Chemical Co. as a 50 weight percent dispersion.

Buffer of pH value of 4.0 was prepared using potassium hydrogen phthalate salt. Phosphate-Citrate pH 4 buffer was prepared with citric acid and sodium phosphate dibasic, both available from Sigma.

TABLE 1
Wax Dispersants and Wax Dispersions

| Wax | | | HLB |
|---|---|---|---|
| Dispersion | Dispersant | Description | Number |
| WAX-1 | D-1 | Tergitol ® TMN-6 | 11.7 |
| | | (2,6,8-trimethyl-4-nonanol ethoxylate) | |
| WAX-2 | D-2 | Lutensol ® TDA 6 | 11 |
| | | (Tridecyl alcohol ethoxylate) | |
| | D-3 | Lutensol ® A 65 N | 12 |
| | | (Lauryl alcohol ethoxylate) | |
| CW-1 | D-4 | Tri-block solvent wax dispersant | — |
| | | PPC-b-PEB-b-PPC | |
| | | Mn = 8.3K (PEB = 2.5K; | |
| | | PPC = 2.9K ea.) | |
| CW-2 | D-5 | Ceramer 1608 ® | — |
| | | (alpha-olefin/maleic anhydride 30 + | |
| | | carbons in alpha-olefin, Mp = 78 C., | |
| | | viscosity = 550 mPa-s @149 C., | |
| | | saponification# = 212) | |

TABLE 2
Pigment Dispersions and Masterbatches

| Pigment | | | |
|---|---|---|---|
| Dispersion | Pigment | Dispersant | Solvent |
| P-1 | PB 15:3 | Solsperse 32000/Solsperse 12000 | Ethyl acetate |
| P-2 | PB 15:3 | Kao E | Ethyl acetate |
| P-3 | PB 15:3 | Masterbatch | — |
| P-4 | PB 15:3 | Polymer of (benzyl methacrylate, | Water |
| | | stearyl methacrylate, and | |
| | | methacrylic acid) | |
| P-5 | PY 74 | Polymer of (benzyl methacrylate, | Water |
| | | stearyl methacrylate, and | |
| | | methacrylic acid) | |

### Preparation of Wax Dispersions

Dispersion WAX-1

A solid particle dispersion of WE-3® wax was prepared by adding 15 g of WE-3 wax, 2.25 g dispersant D-1 (Tergitol TMN-6, 15 wt % with respect to wax), 82.75 g of water and 250 mL of 1.8 mm zirconium oxide beads to a 16 oz glass jar. Small amount of Pluronic 31R1 was added to the mixture to control foaming during milling. The jar was rolled at a speed of 75 ft/min for 5-7 days. After milling, the dispersion was passed through a fine metal screen to separate the dispersion from the beads. The final dispersion was examined by optical microscopy, particle size obtained by dynamic light scattering using the UPA150® Ultrafine Particle Analyzer by Matec Corp.

Dispersion WAX-2

An aqueous dispersion of WE-3® was prepared in water similarly as in WAX-1, except in the presence of D-2 and D-3 (7.5 wt % each with respect to wax) in place of D-1.

Dispersion CW-1

A solid particle dispersion of WE-3® wax in ethyl acetate was prepared by adding 15 g of WE-3® wax, 2.25 g dispersant D-4, 82.75 g of ethyl acetate and 250 mL of 1.8 mm zirconium oxide beads to a 16 oz glass jar and the jar was rolled at a speed of 75 ft/min for 5-7 days.

Dispersion CW-2

Dispersion CW-2 was prepared in the same manner as Dispersion CW-1 except 1.50 g dispersant D-5 was used in place of dispersant D-4 and 83.5 g ethyl acetate was used.

Preparation of Toners from Wax Dispersions

### Procedure for Preparing Comparison Example Toners

A 125 g dispersion in ethyl acetate containing 20 weight percent total solids of Kao E polyester toner binder resin, plus the colorant, charge control agent, and wax as solvent based dispersion (CW-1 or CW-2) was added to 187.5 g of an aqueous phase of a pH 4.0 potassium hydrogen phthalate buffer containing 9.12 g of Nalco® 1060. This mixture was then subjected to very high shear using a Silverson Model L4R mixer, followed by homogenization by a MICROFLUIDIZER® Model 110F homogenizer. After exiting, the oil in water dispersion was diluted 1:1 by weight with water and the ethyl acetate was removed on a rotary evaporator under reduced pressure at 40° C. The silica was removed by raising the pH of the slurry to 12 for 15 minutes. These particles were filtered, washed with water, and dried.

Procedure for Preparing Inventive Example Toners. Method A

To a 125 g dispersion in ethyl acetate containing 20 weight percent total solids of Kao E polyester toner binder resin, plus optional colorant, charge control agent, and polymeric dispersing aid, was added the aqueous wax dispersion (WAX-1 or WAX-2) and mixed with a Silverson Model L4R mixer. After three minutes, 187.5 g of an aqueous phase of a pH 4.0 potassium hydrogen phthalate buffer containing 9.12 g of Nalco® 1060 was added to the crude water-in-oil emulsion. This mixture was then subjected to high shear using the Silverson Model L4R mixer for several minutes, followed by homogenization by a MICROFLUIDIZER® Model 110F homogenizer. After exiting, the oil in water dispersion was diluted 1:1 by weight with water and the ethyl acetate was removed on a rotary evaporator under reduced pressure at 40° C. The silica was removed by raising the pH of the slurry to over 12.0 for 15 minutes. These particles were filtered, washed with water, and dried.

Procedure for Preparing Inventive Example Toners. Method B

A 125 g dispersion in ethyl acetate containing 20 weight percent total solids of Kao E polyester toner binder resin, plus optional colorant, charge control agent, and polymeric dispersing aid compound was added to 187.5 g of an aqueous phase of a pH 4.0 potassium hydrogen phthalate buffer containing 9.12 g of Nalco® 1060 and appropriate amount of aqueous wax dispersion (WAX-1 or WAX-2). This mixture was then subjected to high shear using a Silverson Model L4R mixer, followed by homogenization by a MICROFLUIDIZER® Model 110F homogenizer. After exiting, the oil in water emulsion was diluted 1:1 by weight with water and the ethyl acetate was removed on a rotary evaporator under reduced pressure at 40° C. The silica was removed by raising the pH of the slurry to 12 for 15 minutes. These particles were filtered, washed with water, and dried.

### Charge/Mass (Q/m) Measurements of the Toners

Charge per mass was measured off-line by MECCA method, where the test samples that are measured are prepared by exercising the developer with rotating magnets to create a magnetic field that results in the physical mixing of the particles causing the particles to charge for a period of 2 minutes and then 8 additional minutes. The toner Q/m ratio was measured in a MECCA device comprised of two spaced-apart, parallel, electrode plates which applies both an electrical and magnetic field to the developer samples, thereby causing a separation of the two components of the mixture, i.e., carrier and toner particles, under the combined influence of a magnetic and electric field. A 0.100 g sample of a developer mixture is placed on the bottom metal plate. The sample is then subjected for thirty seconds to a 60 Hz magnetic field and potential of 2000 V across the plates, which causes developer agitation. The toner particles are released from the carrier particles under the combined influence of the magnetic and electric fields and are attracted to and thereby deposit on the upper electrode plate, while the magnetic carrier particles are held on the lower plate. An electrometer measures the accumulated charge of the toner on the upper plate. The toner Q/m ratio in terms of microcoulombs per gram (μC/g) is calculated by dividing the accumulated charge by the mass of the deposited toner taken from the upper plate.

### Covering Power Measurements

The tinctorial strength of the toners was evaluated as a “covering power” value. A series of patches of varying density of toner was prepared on clear film; the weight of toner in each patch and area of each patch was measured. The patches were then fused in an oven controlled at a temperature hot enough such that a continuous thin film of toner resulted. The transmission densities of the resulting patches were measured with a Status A blue filter on an X-Rite densitometer. A straight line was drawn through the data for each toner, and the weight per unit area of toner was then calculated at a transmission density of 1.0. The reciprocal of this value, in units of square centimeters per gram, is defined as the covering power (the area covered to a transmission density of 1.0 by one gram of toner). As the covering power increases, the “yield” of the toner increases, that is, less mass is needed to create the same amount of density/area coverage in a print.

### Comparative Examples C-1, C-2, and C-3

### Preparation of Cyan Toner Containing Various Amounts of Wax from a Solvent-Based Wax Dispersion

Cyan toners containing 4, 6, and 8 weight percent WE-3® were prepared using solvent based wax dispersion CW-1 according to the method described for Comparative Example toners.

### Inventive Examples I-1, I-2, and I-3

### Preparation of Cyan Toner Containing Various Amounts of Wax from an Aqueous-Based Dispersion

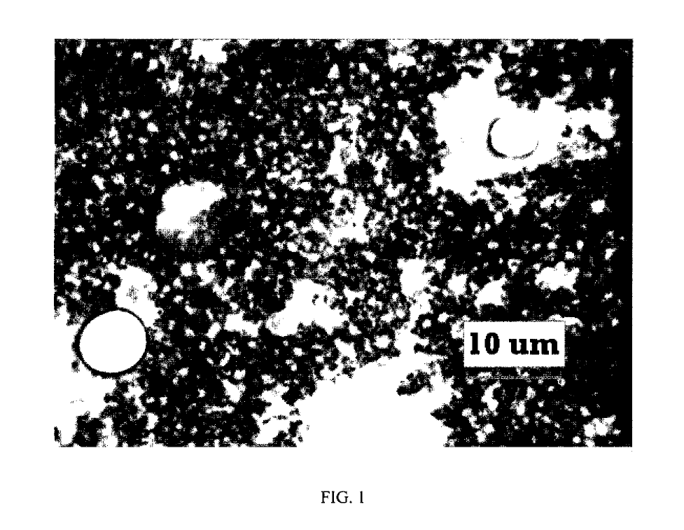

Cyan toners containing 4, 6, and 8 weight percent WE-3 were prepared using aqueous wax dispersion WAX-2, according to Method A described above for Inventive Example toners. The existence of the transient W/O emulsion was examined under optical microscopy and FIG. 1 shows spherical water droplets in the polymer solution phase.

The wax contents in the toner samples were determined by differential scanning calorimetry (DSC); Table 3 shows results for cyan toners prepared using both types of wax dispersions. Comparative toners C-1 through C-3 and inventive toners I-1 through I-3 are demonstrated to contain the expected levels of wax regardless of the source of the wax. Therefore aqueous wax is completely incorporated into the toner particles by the method of the present invention. In addition, Table 3 also shows the toner particle size and particle size distribution for the comparative and inventive toner samples, which suggest that the present invention produces excellent toner samples based on particle size distribution of the toner.

TABLE 3
Wax content determined by DSC measurement
and Particle Size data

| | | | | | Vol | Vol |
|---|---|---|---|---|---|---|
| | Wax | Wax | WE-3 | DSC | Median | Med/ |
| | Disper- | Disper- | in | ΔHm | Diam- | Num |
| Example | sion | sant | toner | (J/g) | eter, μ | Med |
| C-1 (Compar- | CW-1 | D-4 | 8% | 14.93 | 6.31 | 1.092 |
| ison) | | | | | | |
| C-2 (Compar- | CW-1 | D-4 | 6% | 10.34 | 6.37 | 1.091 |
| ison) | | | | | | |
| C-3 (Compar- | CW-1 | D-4 | 4% | 5.80 | 6.15 | 1.083 |
| ison) | | | | | | |
| I-1 (Inven- | WAX-2 | D-2/D-3 | 8% | 14.00 | 6.14 | 1.100 |
| tion) | | | | | | |
| I-2 (Inven- | WAX-2 | D-2/D-3 | 6% | 9.69 | 6.20 | 1.099 |
| tion) | | | | | | |
| I-3 (Inven- | WAX-2 | D-2/D-3 | 4% | 5.65 | 6.38 | 1.093 |
| tion) | | | | | | |

### Inventive Examples I-4 through I-10

### Preparation of Cyan Toners From Various Pigment Sources, Using Various Addenda and Dispersing Aids in Oil Phase According to Method A

Cyan toner particles containing 8.0% WE-3 from WAX-2 were prepared with milled PB15:3 pigment or with PB15:3 supplied through a masterbatch, and with selected addenda such as charge control agent and oil-phase dispersing aid compounds in the oil phase. The detailed compositions of these samples are given in Table 4.

### Inventive Example I-11

### Cyan Toner Prepared with Wax-1 Dispersion According to Method A

In comparing the Comparative with Inventive Examples, complete incorporation of the WE-3 wax into the final toner particles can be ascertained from the DSC data. Charging and fusing of the toner are affected by the aqueous wax dispersants (Examples I-1 to I-3), and incorporation of charge control agent leads to improved and stable charge for the toners of Inventive Examples. Incorporation of oil phase dispersing aids in Examples I-4 through I-10 shows improved fusing performance by the Inventive samples. Therefore, samples prepared from aqueous wax dispersions can give superb charging, fusing, and covering power performances

TABLE 4
Inventive Examples DSC and Particle Size Data

| | | | | | Vol | Vol |
|---|---|---|---|---|---|---|
| | | Wax | Addenda | DSC | Median | Med/ |
| | Pigment | Disper- | (oil | ΔHm | Diam- | Num |
| Example | Source | sion | phase) | (J/g)) | eter, μ | Med |
| I-4 (Inven- | P-1 | WAX-2 | 1.5% CCA | 14.04 | 5.76 | 1.079 |
| tion) | | | | | | |
| I-5 (Inven- | P-1 | WAX-2 | 1.5% CCA | 14.52 | 5.89 | 1.078 |
| tion) | | | 1.2% D-4 | | | |
| I-6 (Inven- | P-1 | WAX-2 | 1.5% CCA | 14.92 | 5.85 | 1.080 |
| tion) | | | 1.2% P2000 | | | |
| I-7 (Inven- | P-1 | WAX-2 | 1.5% CCA | 13.07 | 6.03 | 1.099 |
| tion) | | | 1.2% KS-10 | | | |
| I-8 (Inven- | P-3 | WAX-2 | None | 13.88 | | |
| tion) | | | | | | |
| I-9 (Inven- | P-3 | WAX-2 | 1.5% CCA | 13.06 | | |
| tion) | | | | | | |
| I-10 (Inven- | P-3 | WAX-2 | 1.5% CCA | 16.19 | | |
| tion) | | | 1.2% D-5 | | | |
| I-11 (Inven- | P-1 | WAX-1 | None | 14.91 | | |
| tion) | | | | | | |

TABLE 5
Charge and Covering Power measurement and Oil-less Fusing

| | Wax | | | |
|---|---|---|---|---|
| | Dispersion | | | Q/m, |
| | Temperature | Covering | Q/m, uC/g, | uC/g |
| Toner | failed, ° F. | Power, cm²/g | 2 min | 10 min |
| C-1 | >370 | 2503.7 | −22.00 | −55.00 |
| (Comparison) | | | | |
| C-2 | >370 | 2347.0 | −35.00 | −63.00 |
| (Comparison) | | | | |
| C-3 | 360 | 2312.1 | −39.00 | −56.00 |
| (Comparison) | | | | |
| I-1 (Invention) | 310 | 2630.0 | −28.11 | −31.20 |
| I-2 (Invention) | 310 | 2417.8 | −18.15 | −36.24 |
| I-3 (Invention) | 310 | 2394.2 | −18.93 | −34.11 |
| I-4 (Invention) | >370 | 1875.8 | −50.75 | −73.11 |
| I-5 (Invention) | >370 | 2085.8 | −39.56 | −64.21 |
| I-6 (Invention) | >370 | 1924.0 | −28.57 | −71.21 |
| I-7 (Invention) | >370 | 1937.9 | −73.89 | −107.42 |
| I-8 (Invention) | >370 | 2308.7 | −72.28 | −48.17 |
| I-9 (Invention) | 370 | 1734.0 | −61.45 | −79.07 |
| I-10 (Invention) | 370 | 1998.4 | −80.31 | −88.31 |

The following examples use aqueous dispersions WAX-2 according to Method B. Also, aqueous cyan pigment dispersion P-4 was used.

### Inventive Example 12

Cyan toner according to Method B, where both WAX-2 and P-4 were included in the water phase that contained the Nalco 1060 stabilizer. The resulting toner contained 4.69% PB15:3, 8% WE-3, and 1.5% CCA (FCA-2508N) all based on the total weight of the toner. The particles were found to have a volume median diameter of 6.36μ, with excellent size distribution. And both the pigment and wax are found in the solid toner particles.

The following examples use aqueous dispersions of wax in the second aqueous phase to prepare porous toner particles.

### Example 13

To an organic phase containing 36.94 g of Kao E, 0.563 g of FCA 2508N, and 150.0 g of ethyl acetate was added, with homogenization using a Silverson Model L4R mixer, 30.0 g of a aqueous mill-grind of Pigment Blue 15:3 (10% pigment with 40% polymeric dispersants with respect to pigment). After 2 min of stirring at 5000 rpm, 28.1 g of a 4.0% CMC solution was added and the stirring continued for another 2.0 min. The resulting mixture was further homogenized using a MICROFLUIDIZER operating at about 9000 psi. Next, 187.5 g of this water-in-oil emulsion were added to a second water phase (W2) composed of 280.44 g of pH 4 phosphate-citrate buffer, 16.16 g of Nalco 1060, and 15.90 g of dispersion WAX-2. The mixture was stirred for 2 min at 2000 rpm with a Silverson L4R mixer equipped with a large-hole disintegration head, and the premix was passed through an orifice at a back pressure of about 1000 psi. The resulting double emulsion was diluted with equal weight amount of water and the solvent removed at 40° C. using a rotary evaporator. The particles obtained were treated with KOH solution to remove silica and washed with water, filtered and dried. The sample contained 8.0% PB 15:3, 8.0% WE-3, and 1.5% CCA (FCA-2508N) all based on the total weight of the toner.

### Inventive Example 14

The same procedure of Inventive Example 13 was repeated except that the pigment dispersion used was a Pigment Yellow 74 mill-grind in water containing polymeric dispersants. The sample contained 8.0% PY74, 8.0% WE-3, and 1.5% CCA (FCA-2508N) all based on the total weight of the toner. As Table 6 shows, the wax is completely incorporated into the porous particles.

TABLE 6
Porous toners prepared from aqueous dispersions of wax

| | Pigment | Vol Median | Vol Med/ | | DSC ΔHm |
|---|---|---|---|---|---|
| Example | Source | Diameter, μ | Num Med | Porosity | (J/g) |
| I-13 | P-4 | 5.446 | 1.345 | 35.5% | 12.76 |
| I-14 | P-5 | 5.668 | 1.117 | 30.7% | 13.55 |

1. A method of manufacturing wax-containing polymer particles using a limited coalescence process comprising:
dissolving a polymer binder in a water immiscible organic solvent to form an organic phase solution; combining the organic phase solution with an aqueous phase containing a particulate stabilizer; and emulsifying the resulting mixture to form an oil-in-water emulsion; wherein either (i) an aqueous wax dispersion is added to the organic phase solution to form a transient water-in-oil emulsion prior to combining with the aqueous phase containing particulate stabilizer, or (ii) the aqueous phase containing a particulate stabilizer combined with the organic phase solution further comprises an aqueous wax dispersion; and
removing the solvent from the oil-in-water emulsion to form polymer particles with incorporated wax particles.

2. The method of claim 1 wherein the aqueous wax dispersion is prepared with a dispersant having an HLB value of from about 9 to about 13.

3. The method of claim 1 wherein the aqueous wax dispersion is prepared with a dispersant having an HLB value of from about 10 to about 12.

4. The method of claim 1 wherein the organic phase solution contains a pigment.

5. The method of claim 1 wherein the organic phase solution contains a charge control agent.

6. The method of claim 1 wherein the organic phase solution contains a polymer dispersant having an HLB value of about 2 to 10.

7. The method of claim 1 wherein the water immiscible solvent comprises ethyl acetate, propyl acetate, isopropyl acetate, dichloroethane, or nitromethane, or a mixture thereof.

8. The method of claim 1 wherein the wax is selected from the group consisting of polyolefin waxes, carbonyl group-containing waxes, and fluorinated waxes.

9. The method of claim 1 wherein the wax comprises a long chain aliphatic ester wax.

10. The method of claim 1 wherein the aqueous wax dispersion comprises wax particles having a median particle size of less than 1 micron.

11. The method of claim 10 wherein the wax particles have a median particle size of from 0.2 to 1.0 micron.

12. The method of claim 1, wherein the polymer binder comprises a polyester.

13. The method of claim 1, wherein an aqueous wax dispersion is added to the organic phase solution to form a transient water-in-oil emulsion prior to combining with the aqueous solution containing a particulate stabilizer, and a phase inversion of the transient water-in-oil emulsion is induced by the addition of the aqueous phase containing a particulate stabilizer.

14. The method of claim 13 wherein the aqueous wax dispersion is prepared with a dispersant having an HLB value of from about 9 to about 13.

15. The method of claim 1, wherein the aqueous phase containing a particulate stabilizer comprises an aqueous wax dispersion prior to being combined with the organic phase solution, and the organic phase is directly dispersed into the aqueous phase and then homogenized to form an oil-in-water emulsion.

16. The method of claim 15 wherein the aqueous wax dispersion is prepared with a dispersant having an HLB value of from about 9 to about 13.

17. The method of claim 15, wherein the organic phase solution containing a polymer binder is in the form of a first water-in oil emulsion formed by dispersing a first aqueous phase comprising a pore stabilizing hydrocolloid in the organic phase solution, and the first water-in-oil emulsion is dispersed in an aqueous phase containing particulate stabilizer and an aqueous wax dispersion to form a water-in-oil-in-water double emulsion; and shearing the double emulsion in the presence of the particulate stabilizer to form droplets of the first emulsion in the second aqueous phase; and removing the organic solvent from the droplets to form porous polymer particles with incorporated wax particles.

18. The method of claim 17 wherein the aqueous wax dispersion is prepared with a dispersant having an HLB value of from about 9 to about 13.

19. The method of claim 17, wherein the formed porous polymer particles have a porosity of at least 10 percent.
